(19) United States
(12) Patent Application Publication
(10) Pub. No.: US 2003/0174801 A1
(43) Pub. Date: Sep. 18, 2003

(54) Rack to store fuels from nuclear reactors

(75) Inventors: Luis Costas de la Pena, Cantabria (ES); Javier Tovar Albillos, Cantabria (ES)

Correspondence Address: BROWN & MICHAELS, PC, 400 M & T BANK BUILDING, 118 NORTH TIOGA ST, ITHACA, NY, 14850, US

(73) Assignee: Equipos Nucleares, S.A., Cantabria (ES)

(21) Appl. No.: 10/387,877

(22) Filed: Mar. 13, 2003

(30) Foreign Application Priority Data
Mar. 14, 2002 (ES) P200200606

(51) Int. Cl. G21C 19/00

(52) U.S. Cl. 376/272

(57) ABSTRACT

A rack to store fuels from nuclear reactors, formed by individual cells according to a four corner matching, in which each one of the individual cells (1) is formed by four plates (2) joined along the longitudinal edges, forming a hollow quadrangular prism and open on its bases, in which said plates have crenelated longitudinal edges, provided with protrusions (21), preferably rectangular, of variable length, of a width at least equal to the plate (2) thickness and a fillet weld backing.

### BACKGROUND OF THE INVENTION

1. Field of the Invention

The invention pertains to the field of racks to store fuel from nuclear reactors. More particularly, the invention pertains to construction of racks made from individual welded racks.

2. Description of Related Art

In countries developing nuclear programmes and with nuclear power stations under construction, the need has arisen to compact the storage pool racks in the irradiated fuel area, which nuclear power stations have for such a purpose, using stainless steel racks similar to those used in the past, but bringing the fuels closer together, hence increasing storage capacity. At the end of the 70s and beginning of the 80s, the racks had stainless steel cells, without any additional material acting as a neutronic poison, since the distance or space between cells was so great that the water existing between cells (water gap), treated with boron or not, was sufficient to maintain the set of sub-critical fuel elements. They had a lower grid to support the fuel elements and they were anchored both to the bottom and sides of the pool to form a single interlocked assembly, effectively performing even against earthquakes.

Due to bringing the stored fuel elements closer together to increase pool capacity, an additional material was necessary to control criticality. The materials normally used as neutronic poisons in rack design are, apart from boron treated water, boron treated steel and Boral (a dispersion of a boron carbide in aluminum, or composite metallic plate in the form of a sandwich having an inner core containing boron carbide and having outer layers on opposite sides consisting of aluminum).

Currently, different solutions exist to make the unitary cell and to join them to construct a rack. For example, they involve making two half “U” channels and then welding them along two free edges to form the cell. In another constructive solution, the cells are formed as from four rectangular plates being welded in the thickness in the four edges to form the channel. Then, these channels or cells are joined together by means of an intermittent longitudinal weld in the comers to form a cell matrix forming the rack.

Normally, an arrangement is used with the shape of a chess board, by which the channels form the cells and an additional cell is created by the four channels surrounding it. To make these longitudinal welds, additional intermediate rods or side plates are used when an additional separation between cells is desired, expensive processes derived from the type and volume of required weld.

### SUMMARY OF THE INVENTION

The invention relates to the construction of racks made from individual welded racks, according to four piece corner matching, in which the individual cells consist of four crenelated plates welded in the corners.

These racks are used in nuclear power stations to store both fresh and irradiated fuel in a pool full of water or boron treated water serving as a cooling medium and radiological shielding. Said racks have neutronic poisons to prevent criticality effects. The fuel elements are prismatic elements whose height is much bigger than the other dimensions.

### BRIEF DESCRIPTION OF THE DRAWING

FIGS. 1 and 2 show perspective views of two cells (1) made with four plates (2) having crenelated edges.

FIG. 3a shows in a plan view and FIG. 3b a perspective view of a rack in which the gap of a cell is equal to the gap left by four cells welded in corner.

FIG. 4a shows a plan view and FIG. 4b a perspective view of a rack in which there is a gap between the cells thereof.

FIG. 5 shows a perspective view of a rack in which the gap existing between cells is occupied by tongue and groove strips.

FIG. 6a shows a plan view and FIG. 6b a perspective view of a rack in which there are different gaps.

FIG. 7a shows a plan view and FIG. 7b a perspective view of another embodiment of a cell, in this case formed by “L”-curved plates.

FIG. 8 shows another embodiment in which the cells are coupled by tongue and groove.

### DETAILED DESCRIPTION OF THE INVENTION

The solution proposed by the present invention consists of a structure based as from four plates with crenelated longitudinal edges. Said crenels are protrusions existing on the edges, preferable rectangular shape. The crenels have a variable length and their width is at least the thickness of the plate, plus an additional width serving as the fillet weld backing. The crenels existing on a plate coincide with zones not having them on the adjacent plate with which it forms a corner; on each plate, crennels may be alternated with a zone of equal length having no protrusion; likewise, these crenels may be arranged along the entire length of the plates opposite, or in specific zones thereof.

The four plates are then joined by very simple fillet welds to form the channel or unitary cell. The length of these intermittent longitudinal cells will depend on the loads this structure should support in each case, external actions like earthquakes.

Finally, the unitary cells will be joined to other cells in a chess board arrangement by means of fillet welds, without any intermediate part to form the rack assembly.

Several arrangements may be obtained with this structure. In the simplest, the cell gap is equal to that left by the four cells welded in corner. This arrangement is suitable when a structural material used is also serving as neutronic poison, that is: boron treated steel. In this arrangement, it is necessary to leave a negative creneling on the individual plates serving to house the plate crennels of the other cell welded in the corner. The width of these housings is such that they do not invalidate the neutronic criticality calculation and moreover, permit fillet welding between plates of the individual cells joined in the corner, achieving a very simple method to join cells. The volume (length) of the longitudinal fillet welds joining cells in the corner will depend on the external requirements for each case.

This methodology of cells formed from fillet welded crenelated plates and then joined to other cells by fillet welding without inserting intermediate plates or rods may also be applied to the case in which we want to leave an intermediate gap between cells (water gaps). The need to leave a gap between plates is to increase the neutronic moderation capacity. When the width of the water gap is small, the crennels are extended along the length determined by the water gap (the order of magnitude of the water gap is 5 mm for Boiler type power stations), permitting fillet welds to join cells with adjacent ones. With a cell assembly sequence from left to right and top to bottom, each cell is fillet welded to the adjacent ones in three corners since there is no access in the fourth corner, except at the ends. This type of joint is sufficient from a structural point of view. When the width of the water gap is important (more than 40 mm for Pressuriser type power stations), the adopted solution consists of inserting the crenelated cells, formed by the described process, in double walled grids made by the tongue and groove system. These double walled grids guarantee the minimum width demanded (water gap). Normally, the cells will be welded to the grid, but other joining processes are possible.

Finally, arrangements may also be constructed, which require the channel gap to be less than the gap left by four channels forming a cell and welded in the corner. This construction is necessary when the neutronic poison material is different from the structural one. Then the individual cells are formed by the normal fillet welded, crenelated plate process. Later (or before) a wrap is welded on incorporating the neutronic poison (normally Boral (a dispersion of a boron carbide in aluminum, or composite metallic plate in the form of a sandwich having an inner core containing boron carbide and having outer layers on opposite sides consisting of aluminum)). Finally, the individual cells are welded by means of longitudinal welds in the comers in the accessible part according to the assembly stage, such that the cells are welded in the four corners. The cells are transversely displaced along the suitable length, such that the gap formed by the four cells welded in corner (not counting the neutronic poison material), is equal to or somewhat larger than the individual cell gap.

The described solutions start from cells formed by four plates welded in the corners, but the processes are also valid for cells formed from two curved plates, crenelated in “L” and then welded in the crennels.

Another embodiment variation consists of making individual cells, by means of tongue and groove in the profiles with needing welds. Each cell will be joined to the others by welds according to the same criteria as in the previous solutions.

The rack, object of the present invention, is constructed as from individual cells welded according to a four piece corner matching, where the individual cells (1) are formed by four plates (2) with crenelated longitudinal edges.

As observed in the figures, the mentioned crennels are protrusions (21) existing on the edges, preferably of a rectangular shape, variable length, and width at least equal to the thickness of the plate (2), plus a backing (about 5 mm) for the fillet weld to form the cells.

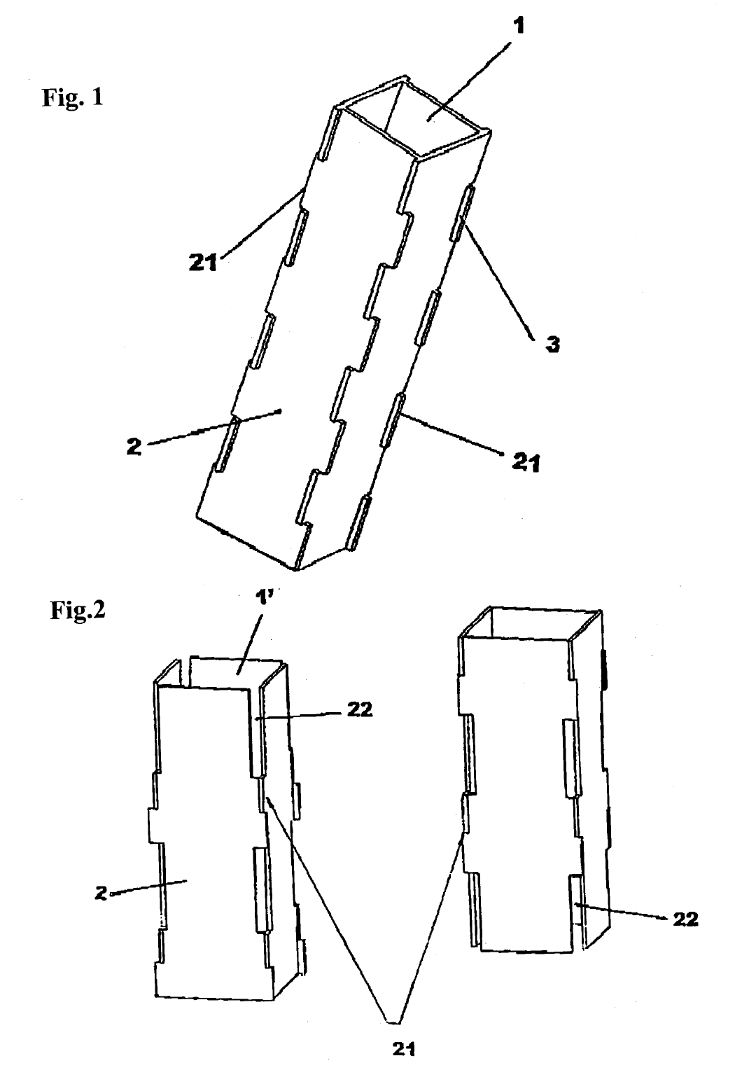

The crennels existing on a plate (2) coincide with zones not having them in the adjacent plate with which it forms a corner; on each plate, crennels (21) may be alternated with a zone of equal length having no protrusion; likewise, these crenels may be arranged the entire length of the plates opposite to each other, as observed in FIG. 1 or in specific areas thereof, as may be seen in FIG. 2.

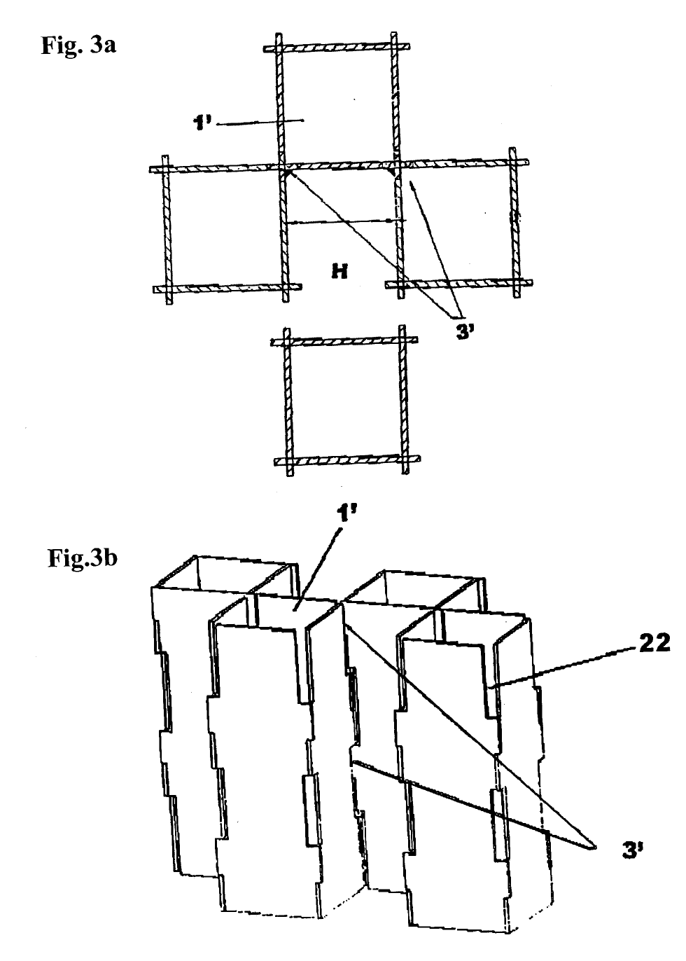

The four plates (2) are then joined by fillet welding (3) to form the channel or unitary cell. Finally, the unitary cells (1) are joined to other cells in a chess board arrangement, by means of fillet welds to form the rack assembly shown in FIGS. 3a-3b, 4a-4b and 5.

By means of these types of construction, plan arrangements may be obtained like those shown in FIGS. 3a and 3b, where the cell gap (1′) is equal to the gap (H) left by the four cells welded in corner (31). This arrangement is suitable when a structural material used is also the same one serving as neutronic poison, that is: boron treated steel, without the need of a water gap.

In this arrangement, it is necessary to leave negative creneling (22) in the individual plates, serving to permit housing the plate (2) crennels (21) of the other cell (1′) welded in the corner (see FIG. 2). The width of these housings is such that they do not invalidate the neutronic criticality calculation and moreover, permit fillet welding between the plates of the individual cells joined in the corner.

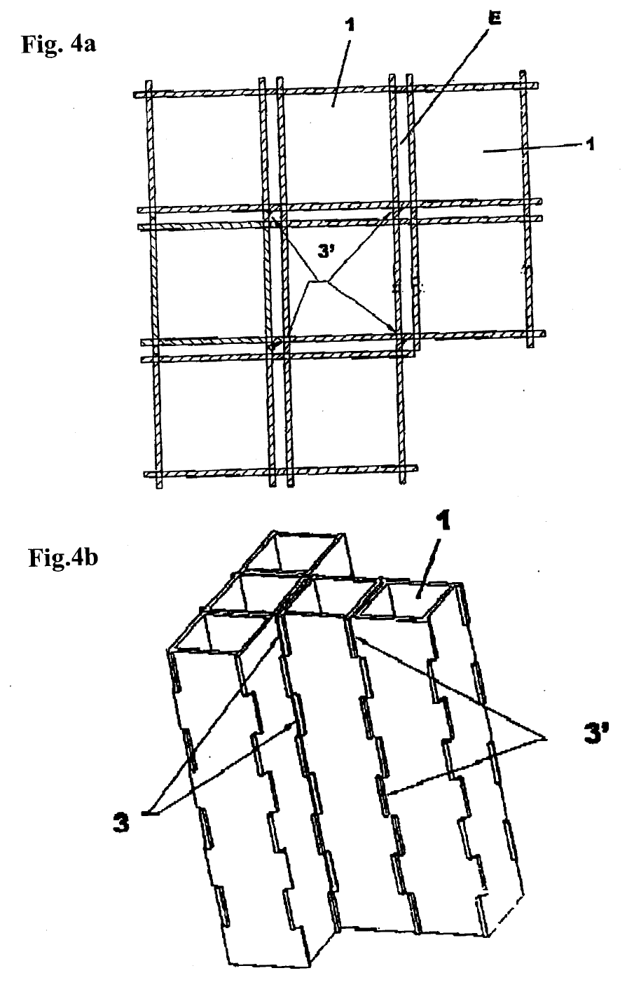

This methodology of cells formed from fillet welded crenelated plates and then joined to other cells by fillet welding (3), like those shown in FIG. 1, may also be applied to the case of wanting to leave an intermediate gap (E) between cells (water gaps), as shown in FIGS. 4a and 4b. The crennels are extended along the length determined by the water gap carrying out fillet welds (3′) to join each cell (1) with the adjacent ones. With a cell assembly sequence from left to right and top to bottom, each cell is fillet welded to the adjacent ones in three corners, since there is no access in the fourth corner, except at the ends.

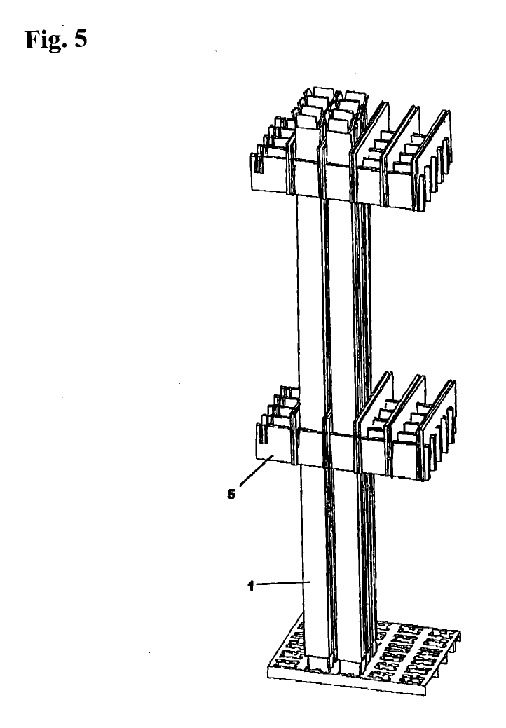

When the width of the water gap is important (more than 40 mm for pressuriser type power stations), the adopted solution consists of inserting the crenelated cells, formed by the process described, in double walled grids (5) made by the tongue and groove system. These double walled grids assure the minimum distance (water gap) demanded. Normally, the cells will be welded to the grid, but other joining processes are possible. See FIG. 5.

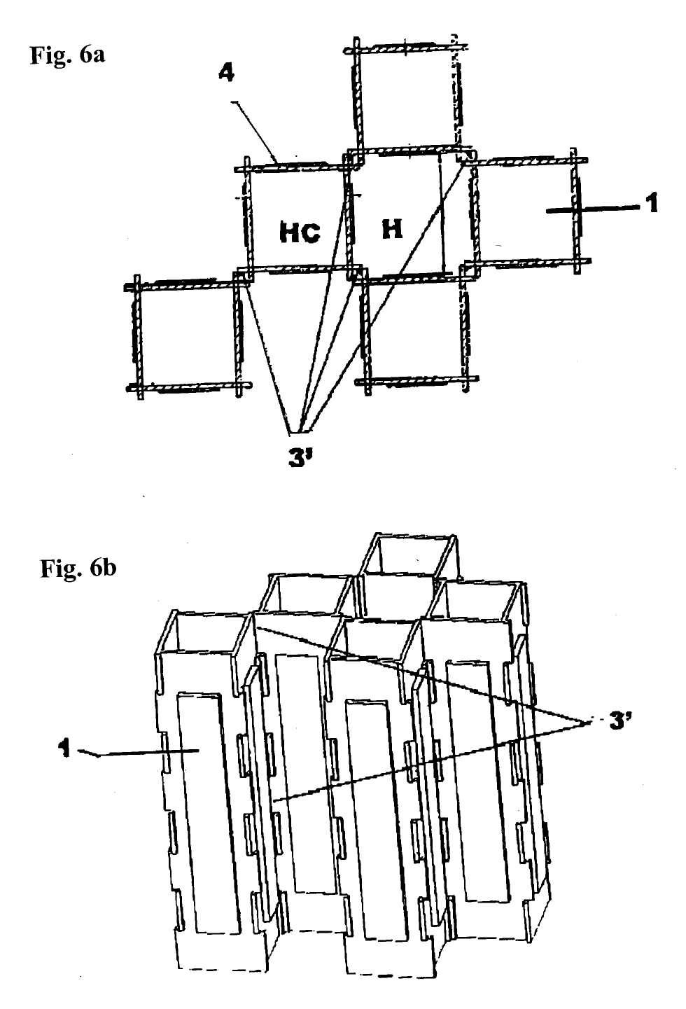

Other arrangements may also be constructed where the channel gap (HC) is less than the gap (H) left by four channels welded in the corner and forming a cell. See FIGS. 6a and 6b. This construction is necessary when the neutronic poison material (4) is different from that of the plate. Then, the individual cells are formed by the normal process for fillet welded crenelated plates, as shown in FIG. 1. A wrap incorporating the neutronic poison (4) is welded on, preferably Boral (a dispersion of a boron carbide in aluminum, or composite metallic plate in the form of a sandwich having an inner core containing boron carbide and having outer layers on opposite sides consisting of aluminum). Finally, the individual cells (1) are welded by means of longitudinal welds in the corners in the accessible part, according to the assembly step, such that the cells are welded in the four corners (3). The cells (1) are transversely displaced along the suitable length, such that the gap formed by the four cells welded in the corner, not counting the neutronic poison material, is equal to or somewhat greater than the gap of the individual cells.

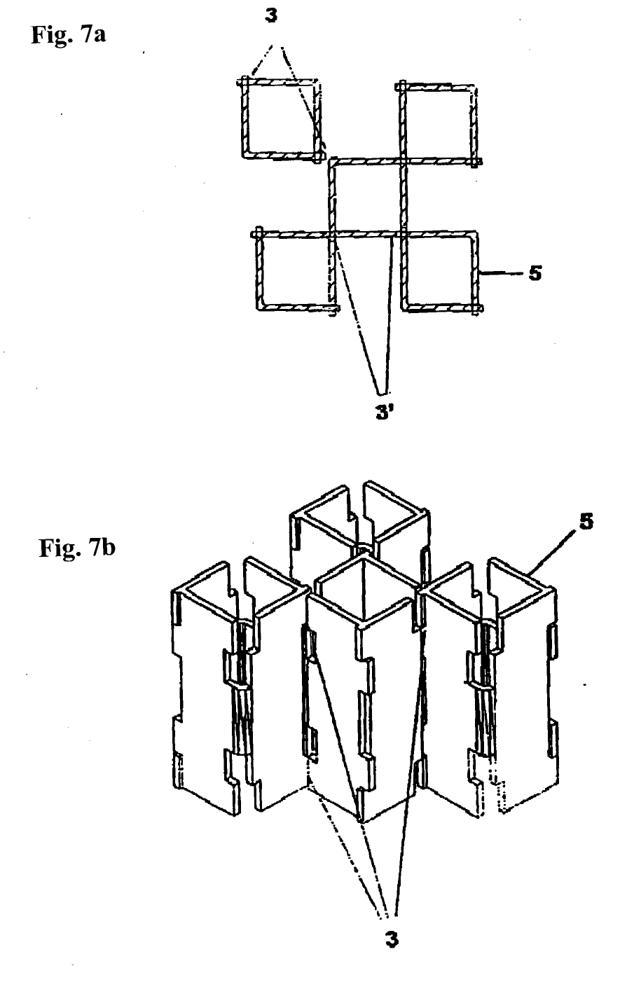

The solutions described until now start from cells formed by four plates (2) welded in the corners, but the processes are also valid for cells formed by two “L”-shaped plates (5), crenelated on the edges and then welded in the crennels, according to the aforementioned embodiments. See FIGS. 7a and 7b.

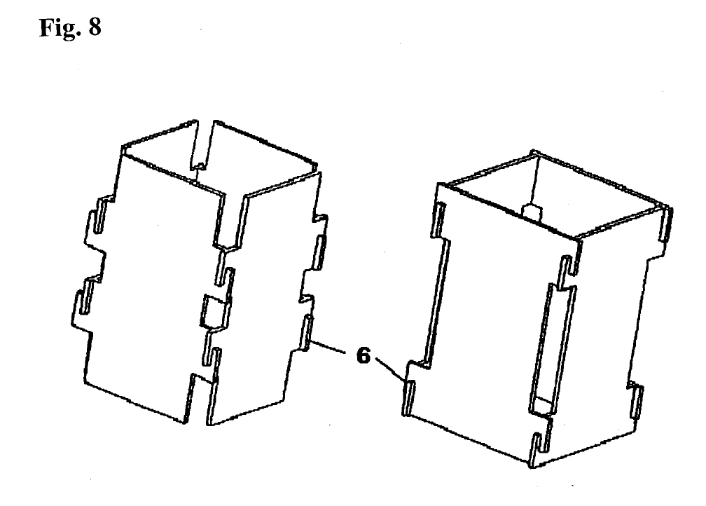

Another variant also included in the present invention foresees individual cells having hook-shaped protrusions (6) on the edges joined by means of dovetailing, as may be observed in FIG. 8, without needing welds. Each cell is joined to the others with welds following the same criteria as in previous embodiments.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A rack to store fuels from nuclear reactors, formed by individual cells, welded according to a four corner matching, in which each one of the individual cells (1) is formed by four plates (2) joined along the longitudinal edges forming a hollow quadrangular prism, open on its bases, characterised in that said plates have their crenelated longitudinal edges provided with protrusions (21), preferably of a rectangular shape, a variable length, and a width at least equal to the thickness of the plate (2) plus a fillet weld backing.

2. The rack of claim 1, in which each of the plates has a negative creneling (22) permitting housing the crenels (21) of the plate (2) of another cell (1′) welded in the corner.

3. The rack of claim 1, in which a structural material used is also serving as a neutronic poison and a gap (HC) of each cell (1′) is equal to the gap (H) left by the four cells welded by their corners with fillet welding (3′).

4. The rack of claim 1, in which each cell (1) is welded to adjacent cells by a part of each crennel (21) protruding from the overlapping plate (2), forming a gap (E) between cells (1).

5. The rack of claim 4, in which the minimum distance of separation between cells is achieved by inserting double walled grids (5) between the crenelated cells (1), made by means of two plates, perpendicularly joined by means of tongue and groove and welded to the cells.

6. The rack of claim 1, in which each cell (1) has a smaller gap than that left by the four cells welded in the corner, welding on an wrap incorporating a neutronic poison.

7. The rack of claim 1, in which the cells (1) are formed by two “L”-shaped plates (5), crenelated on their edges and then longitudinally welded along the edges.

8. The rack of claim 1, in which the cells (1) are formed with plates (2) having hook-shaped protrusions (6) on their edges, joined by means of tongue and groove and joining each cell to the next by means of welding.
